(19) United States
(12) Patent Application Publication
(10) Pub. No.: US 2014/0367434 A1
(43) Pub. Date: Dec. 18, 2014

(54) CUP HOLDER AND STORAGE BIN ASSEMBLY

(71) Applicant: FORD GLOBAL TECHNOLOGIES, LLC, Dearborn, MI (US)

(72) Inventors: Scott Simon, Dexter, MI (US); Gary Bondy, Taylor, MI (US); Vishnukumar Sivanandham, Canton, MI (US); Eric Rifel, Newark, CA (US)

(21) Appl. No.: 14/332,571

(22) Filed: Jul. 16, 2014

Related U.S. Application Data
(63) Continuation-in-part of application No. 13/916,875, filed on Jun. 13, 2013.

(51) Int. Cl. B60N 3/10

(52) U.S. Cl. CPC B60N 3/105
USPC 224/485

(57) ABSTRACT

A removable cup holder insert includes a support body, a first flap and a roll pin pivotally mounting the first flap to the support body. A first spring biases the first flap so as to pivot on the roll pin outwardly from the support body so that it can engage and steady a beverage container in position in a cup holder to which the insert is mounted.

This utility patent application is a continuation-in-part of U.S. patent application Ser. No. 13/916,875 filed on Jun. 13, 2013 and entitled “CUP HOLDER AND STORAGE BIN ASSEMBLY”, the full disclosure of which is incorporated herein by reference.

### TECHNICAL FIELD

This document relates generally to cup holder assemblies for vehicles, and more particularly, to a removable cup holder insert received and held in such an assembly.

### BACKGROUND

Vehicles often have fixed cup holders disposed in the console for storing beverages and other items for the vehicle occupants. In order to provide maximum utility, such a cup holder must be adapted to hold varying sizes and shapes of cups or beverage containers in a secure and effective manner so as to prevent the cup/container from tipping over during vehicle operation.

This document relates to a removable cup holder insert particularly adapted to serve this function in an efficient, effective and reliable manner over a long service life.

### SUMMARY

In accordance with the purposes and benefits described herein, a removable cup holder insert is provided. That removable cup holder insert comprises a support body, a first flap, a roll pin pivotally mounting the first flap to the support body, and a first spring biasing the first flap so as to pivot on the roll pin outwardly from the support body. In one embodiment the roll pin is made from steel.

More specifically, the support body includes a first pair of mounting bosses. The first flap is pivotally mounted between the first pair of mounting bosses on the roll pin. Further the roll pin extends continuously between the first pair of mounting bosses. The first spring is received and held on the roll pin.

In another embodiment the insert includes a second flap, a second roll pin pivotally mounting the second flap to the support body and a second spring biasing the second flap so as to pivot on the second roll pin outwardly from the support body. In this embodiment the support body includes a second pair of mounting bosses and the second flap is pivotally mounted between the second pair of mounting bosses on the second roll pin. That second roll pin extends continuously or uninterrupted between the second pair of mounting bosses. Further the second spring is received and held on the second roll pin. In this embodiment the first flap is mounted to a first side of the support body and the second flap is mounted to a second, opposite side of the support body.

In accordance with an additional aspect a cup holder assembly is provided. That cup holder assembly comprises a cup well, a floor received in the cup well and displaceable therein in order to adjust a depth of the cup well, a receiver carried on the floor, and a removable cup holder insert received and held in the receiver. The removable cup holder insert includes the features and structure as outlined above and discussed in detail below.

In the following description, there is shown and described several preferred embodiments of the removable cup holder insert and cup holder assembly. As it should be realized, the insert and assembly are capable of other, different embodiments and their several details are capable of modification in various, obvious aspects all without departing from the insert and assembly as set forth and described in the following claims. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the removable cup holder insert and cup holder assembly and together with the description serve to explain certain principles thereof. In the drawings:

FIG. 1 is a perspective view of the removable cup holder insert.

FIG. 2 is an exploded perspective view of the insert illustrated in FIG. 1.

FIG. 3 is a perspective view illustrating the pivoting movement of the first flap of the removable cup holder insert illustrated in FIGS. 1 and 2.

FIG. 4 is a perspective view from above illustrating the cup holder assembly including the cup well, floor, receiver and removable cup holder insert.

FIG. 5 is a fragmentary cross-sectional view of the cup holder assembly (insert removed) including the receiver and floor as supported on a track member of the cup holder housing which forms the cup well.

Reference will now be made in detail to the present preferred embodiments of the removable cup holder insert and cup holder assembly, examples of which are illustrated in the accompanying drawings.

### DETAILED DESCRIPTION

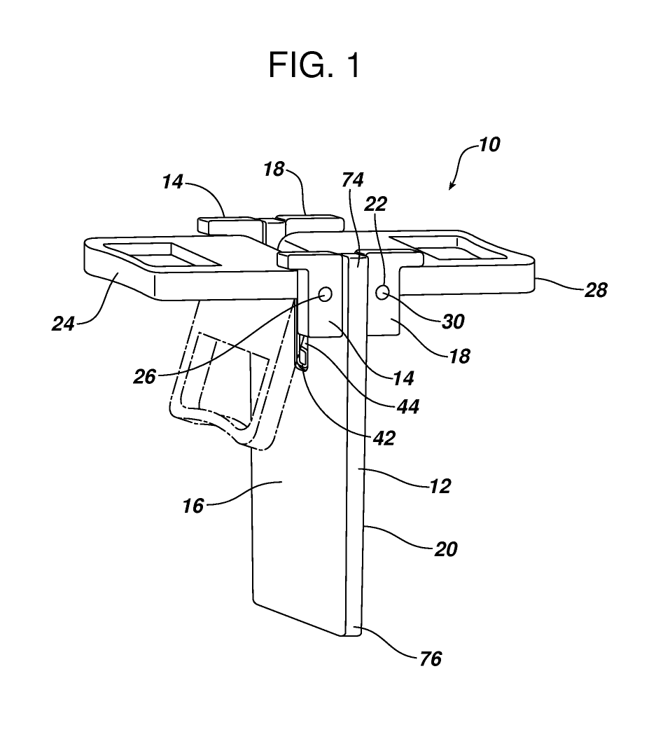

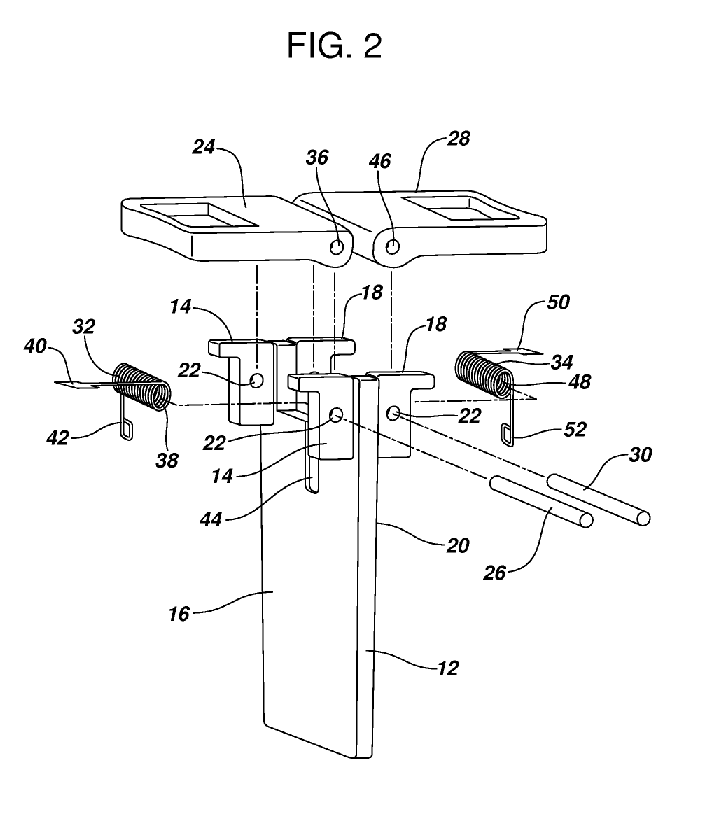

Reference is now made to FIGS. 1 and 2 illustrating a removable cup holder insert 10. The removable cup holder insert 10 includes a substantially planar support body 12. A first pair of mounting bosses 14 are provided on a first side 16 of the support body. A second pair of mounting bosses 18 are provided on a second opposite side 20 of the support body 12. Each of the mounting bosses 14, 18 includes an aperture 22 that extends through the entire width of the boss.

A first flap 24 is mounted between the first pair of bosses 14 on the first side 16 of the support body 12 by means of a roll pin 26. A second flap 28 is mounted between the second pair of mounting bosses 18 on the second side 20 of the support body 12 on a second roll pin 30. A first torsion spring 32 is provided to bias the first flap 24 outwardly from the support body 12 into the position illustrated in FIG. 1. Similarly, a second torsion spring 34 is provided to outwardly bias the second flap 28 into the outwardly extending position illustrated in FIG. 1.

The removable cup holder insert 10 is constructed by aligning the central opening 38 in the first torsion spring 32 between the mounting apertures 36 in the first flap 24 and the apertures 22 in the first pair of mounting bosses 14 and then inserting the first roll pin 26 to secure these component parts in position. Here it should be noted that a first end 40 of the torsion spring engages the underside of the first flap 24 while the second end 42 of the first torsion spring engages in the recess 44 formed in the support body 12.

The second flap 28 is mounted to the support body by aligning the central opening 48 in the second torsion spring 34 between the mounting apertures 46 in the second flap with and the apertures 22 in the second pair of mounting bosses 18. The second roll pin 30 is then inserted through these aligned components to complete the connection. In this instance the first end 50 of the second torsion spring 34 engages the second flap 28 while the second end 52 of the second torsion spring 34 engages in a recess (not shown) on the second side 20 of the support body 12.

It should be appreciated that the two roll pins 26, 30 are self-retaining fasteners: that is, they provide a friction fit to hold the various components of the device 10 together. More specifically, the pins 26, 30 have a body diameter which is larger than the diameter of the mounting apertures 22 in the bosses 14, 18 but have a chamfer on either one or both ends to allow insertion. The spring action of the pins 26, 30 allows them to compress and assume the diameter of the apertures 22. At the same time, the apertures 36, 46 in the flaps 24, 28 are slightly larger in diameter so as to pivot freely on the pins 26, 30 under the force of the respective springs 32, 34.

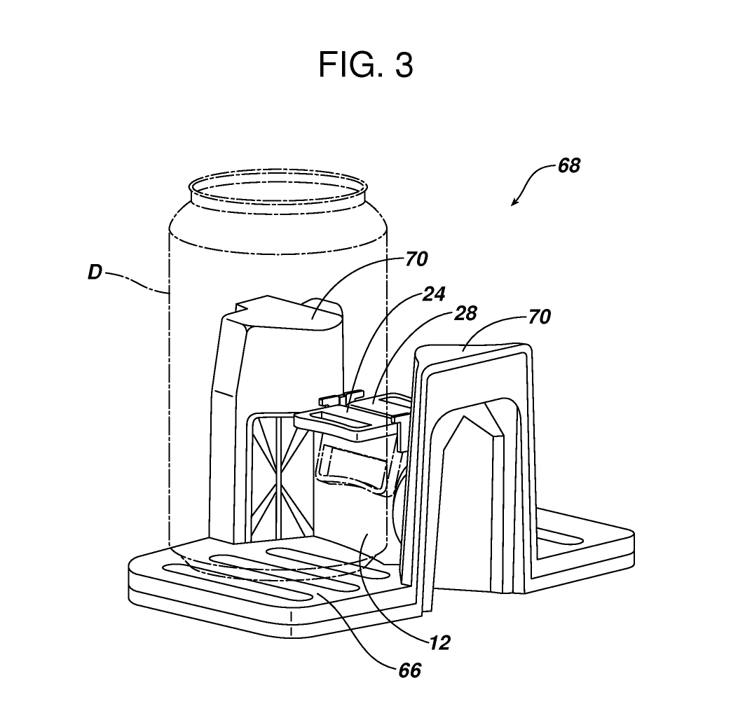

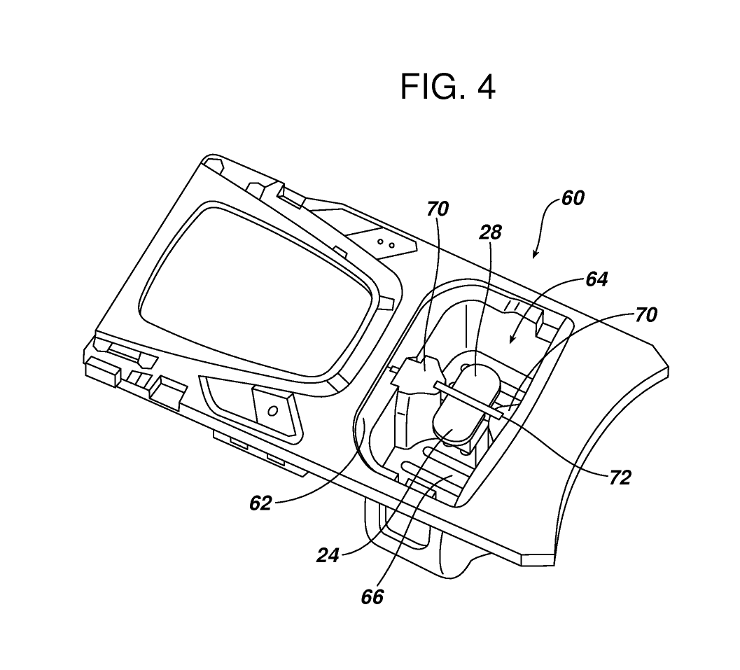

Reference is now made to FIGS. 3 and 4 which generally show the cup holder assembly 60 comprising an outer housing 62 which forms a cup well 64. A floor 66 is received in the cup well 64 and is displaceable therein in order to adjust the depth of the cup well. A receiver 68 is carried on the floor 66. In the illustrated embodiment the receiver 68 comprises a pair of posts 70. Each post includes a slot or channel 72. The support body 12 of the removable cup holder insert 10 is slidably received in the channels 72 formed in the posts 70 where it is securely held by the receiver 68. In order to aid in completing the connection, it should be appreciated that the support body 12 may be tapered slightly from the top end 74 toward the bottom end 76 in the width direction and/or the thickness direction (see also FIG. 1).

As should be appreciated, the receiver posts 70 are secured to the floor 66 and, in fact the two may be integrally molded as a single part from an appropriate plastic material if desired. As illustrated in FIG. 4, at least one of the posts 70 includes an attachment or coupling mechanism 78 which is disposed within a channel 80 of a track member 82 formed in the outer housing 62. The attachment or coupling mechanism 78 includes a release button 84 which is adapted to release the attachment mechanism from engagement with any one of the notches 86, 88, 90 disclosed on the housing 62.

It is contemplated that the release button 84 is a spring biased release button, such that the release button is biased in a direction indicated by arrow A to an outward or engaged position. When a user wishes to adjust the vertical height of the floor 66, the user presses the release button 84 inwardly in a direction indicated by action arrow B, such that a pawl member 92 moves in a direction as indicated by action arrow C from an engaged position, as shown in FIG. 4, to an unengaged position. Thus, the pawl member 92 is mechanically coupled to the release button 84 and is also biased to the engaged position in a direction as indicated by arrow A much like the release button.

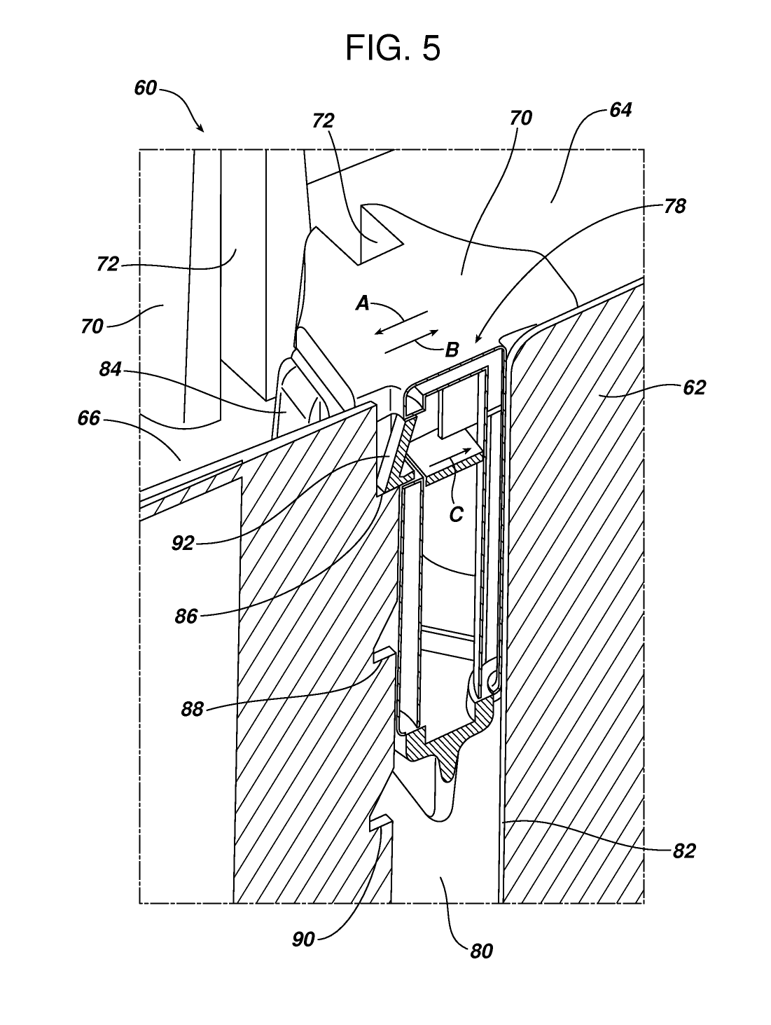

As further shown in FIG. 5, the pawl member 92 is engaged with a notch or detent 86. When the release button 84 is pressed, the pawl member 92 moves to the unengaged position in a direction that is indicated by action arrow C such that the floor 66 can be moved to either of the notches 88, 90 or even removed from the housing 62 altogether if desired.

With the pawl member 92 biased toward the engaged position, the user need only press the release button 84 long enough to disengage the pawl member with the corresponding notch of detent 86, 88, or 90 to allow the floor 66 to be moved downward or upward until the pawl member is again aligned with the next vertically disposed notch or detent. When the pawl member 92 is so aligned, the biased pawl member will automatically move to the engaged position under the influence of the biasing spring to retain the floor 66 at the desired height level. Of course the user may hold the release button 84 in the depressed, unengaged position so that the floor 66 moves more freely along the track member 82 of the housing 62 when making an adjustment to the depth of the cup well 64 to accommodate a taller or shorter cup or other object.

No matter what the position of the floor 66 in the cup well 64, the spring biased flaps 24, 28 of the insert 10 ensure that a beverage in a cup or can is securely held in the cup well in an upright position. More specifically, as illustrated in FIG. 3, when a can D is positioned in the cup well 64 on the floor 66 within the housing 62 on a first side of the receiver 68, the bottom portion of the can engages the flap 24 forcing it to pivot downwardly. However, it should be appreciated that the first torsion spring 32 continues to bias the first flap so that it pivots outwardly from the support body 12 and remains in engagement with the side of the can D. There the flap 24 effectively “grips” and holds the can D in the cup holder assembly 60 to prevent spilling. Here it should be appreciated that the biasing force of the spring 32 is only sufficient to help secure and steady the can D in position and is not so strong as to create any difficulty when inserting the can in the cup well 64 or removing the can to take a drink.

Preferably, the roll pins 26, 30 which secure the respective flaps 24, 28 and torsion springs 32, 34 to the support body 12 are made from steel. Steel pins 26, 30 have the strength to resist bending and will function to hold the parts together over the course of a very long service life which will include a multitude of times wherein the flaps 24, 28 are pivoted between the fully outwardly extended and partially or fully retracted positions. Thus, use of the steel roll pins 26, 30 provides significant benefits and clearly advances the removable cup holder insert art.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A removable cup holder insert, comprising:
a support body;
a first flap;
a roll pin pivotally mounting said first flap to said support body; and
a first spring biasing said first flap so as to pivot on said roll pin outwardly from said support body.

2. The insert of claim 1, wherein said roll pin is made from steel.

3. The insert of claim 1, wherein said support body includes a first pair of mounting bosses, said first flap being pivotally mounted between said first pair of mounting bosses on said roll pin.

4. The insert of claim 3, wherein said roll pin extends continuously between said first pair of mounting bosses.

5. The insert of claim 4, wherein said first spring is received and held on said roll pin.

6. The insert of claim 5, wherein said roll pin is made from steel.

7. The insert of claim 6, further including a second flap, a second roll pin pivotally mounting said second flap to said support body and a second spring biasing said second flap so as to pivot on said second roll pin outwardly from said support body.

8. The insert of claim 7, wherein said support body includes a second pair of mounting bosses, said second flap being pivotally mounted between said second pair of mounting bosses on said second roll pin.

9. The insert of claim 8, wherein said second roll pin extends continuously between said second pair of mounting bosses.

10. The insert of claim 9, wherein said second spring is received and held on said second roll pin.

11. The insert of claim 10, wherein said first flap is mounted to a first side of said support body and said second flap is mounted to a second, opposite side of said support body.

12. The insert of claim 11, wherein said second roll pin is made from steel.

13. A cup holder assembly, comprising:
a housing including a cup well;
a floor received in said cup well and displaceable therein in order to adjust a depth of said cup well;
a receiver carried on said floor;
a removable cup holder insert received and held in said receiver; and
said removable cup holder insert including (a) a support body, (b) a first flap, (c) a roll pin pivotally mounting said first flap to said support body, and (d) a first spring biasing said first flap so as to pivot on said roll pin outwardly from said support body.

14. The assembly of claim 13, wherein said roll pin is made from steel.

15. The assembly of claim 13, wherein said support body includes a first pair of mounting bosses, said first flap being pivotally mounted between said first pair of mounting bosses on said roll pin.

16. The assembly of claim 15, wherein said roll pin extends continuously between said first pair of mounting bosses.

17. The insert of claim 16, wherein said first spring is received and held on said rod pin.

18. The assembly of claim 17, wherein said roll pin is made from steel.

19. The assembly of claim 18, further including a second flap, a second roll pin pivotally mounting said second flap to said support body and a second spring biasing said second flap so as to pivot on said second roll pin outwardly from said support body.

20. The assembly of claim 13, wherein said well includes a track member having a plurality of detents vertically disposed along said track member and said floor includes a coupling mechanism adapted to engage any one of said plurality of detents to support said floor at different vertical positions within said well.
